(19) United States
(12) Patent Application Publication
(10) Pub. No.: US 2015/0033866 A1
(43) Pub. Date: Feb. 5, 2015

(54) Optical Sensor

(71) Applicant: PinTrust Photonics Inc., Zhubei City (TW)

(72) Inventors: Mao-Jen Wu, Kaohsiung City (TW); Chia-Chi Chang, Taipei City (TW)

(21) Appl. No.: 14/449,162

(22) Filed: Aug. 1, 2014

Related U.S. Application Data
(60) Provisional application No. 61/861,438, filed on Aug. 2, 2013.

(51) Int. Cl. G01H 9/00

(52) U.S. Cl. CPC G01H 9/00
USPC 73/655

(57) ABSTRACT

An optical sensor is proposed. The optical sensor comprises a first substrate, a second substrate, a membrane, and an optical gate. The first substrate has a concave structure having a first optical micro-reflection surface and a second optical micro-reflection surface formed thereon. The second substrate has a second concave structure having a third optical micro-reflection surface and a fourth optical micro-reflection surface formed thereon. The optical gate is disposed on the membrane within the first concave structure. The membrane is disposed between the first substrate and the second substrate.

### CROSS-REFERENCE TO RELATED APPLICATION

This application claims the benefit of U.S. Provisional Application No. 61/861,438, filed Aug. 2, 2013.

### TECHNICAL FIELD

The present invention relates to an optical sensor, and more particularly, to an optical sensor to measure vibration in an optical sensor system.

### BACKGROUND

Recently, the use of fiber optic sensors has become more prevalent for sensing applications, particularly in those applications where the sensors must be placed in harsh environments, which seriously affects the performance/reliability of the associated electronics. Fiber optic sensors have an advantage in that they require no electronics at or near the sensor. In fiber optic sensors, light is sent through the optical fiber from a remote location.

Fiber optic sensors generally fall into two categories, those designed for making high speed dynamic measurements, and those designed for low speed, relatively static measurements. Examples of dynamic sensors include hydrophones, geophones, and acoustic velocity sensors, where the signal varies at a rate of 1 Hz and above. Examples of low speed (static) sensors include temperature, hydrostatic pressure, and structural strain, where the rate of signal change may be on the order of minutes or hours. Many applications relate primarily to dynamic measurements of acceleration, acoustic velocity, and vibration using fiber optic sensors.

### SUMMARY

In the present invention, an optical sensor is proposed. The optical sensor comprises a first substrate, a second substrate, a membrane, and an optical gate. The first substrate has a concave structure having a first optical micro-reflection surface and a second optical micro-reflection surface formed thereon. The second substrate has a second concave structure having a third optical micro-reflection surface and a fourth optical micro-reflection surface formed thereon. The optical gate is disposed on the membrane within the first concave structure. The membrane is disposed between the first substrate and the second substrate. A light source and at least one photo detector may be integrated with the optical sensor to be as an optical sensing system. The optical sensor may be a single optical sensor or an optical sensor array.

According to one aspect of the invention, the optical sensor comprises a substrate with an optical micro-reflection surface, a membrane, and an optical gate.

According to another aspect of the invention, the optical sensor comprises a substrate with an optical micro-reflection surface and a membrane.

According to one aspect of the invention, the optical sensor system comprises an optical sensor and a third substrate, wherein an optical component and a photoelectric conversion component are integrated on the third substrate, wherein the optical component aligns substantially to the first optical micro-reflection surface of the first substrate, and the photoelectric conversion component aligns substantially to the second optical micro-reflection surface of the first substrate or the optical gate.

The third substrate is a printed circuit board. The optical component is a light source, and the photoelectric conversion component is a photo detector.

According to another aspect of the invention, the optical sensor system comprises an optical sensor and at least one optical cable aligning substantially to the first optical micro-reflection surface of the first substrate, the second optical micro-reflection surface of the first substrate or the optical gate.

The optical sensor system further comprises a photoelectric conversion component disposed under the optical gate.

The light source is capable of emitting visible and invisible light. In one embodiment, at least one groove is formed on the concave structure of the first substrate. Based-on the at least one groove of the concave structure, optical component (cable) may be passively aligned to the at least one groove.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates an optical sensor according to one embodiment of the present invention;

FIG. 2 illustrates a structure of the optical sensor of the FIG. 1;

FIG. 3 illustrates a signal wave detected by an optical sensor according to one embodiment of the present invention;

FIG. 4A and 4B illustrate vibration of membrane and optical gate according to one embodiment of the present invention;

FIG. 5 illustrates an optical sensor system according to one embodiment of the present invention;

FIG. 6 illustrates an optical sensor system package according to one embodiment of the present invention;

FIG. 7 illustrates an optical sensor system according to one embodiment of the present invention;

FIG. 8 illustrates an optical sensor system package according to one embodiment of the present invention;

FIG. 9 illustrates an optical sensor system package according to one embodiment of the present invention;

FIG. 10 illustrates an optical sensor system package according to one embodiment of the present invention;

FIG. 11 illustrates an optical sensor according to another embodiment of the present invention;

FIG. 12 illustrates an optical sensor according to yet another embodiment of the present invention;

FIG. 13 illustrates an optical sensor according to one embodiment of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

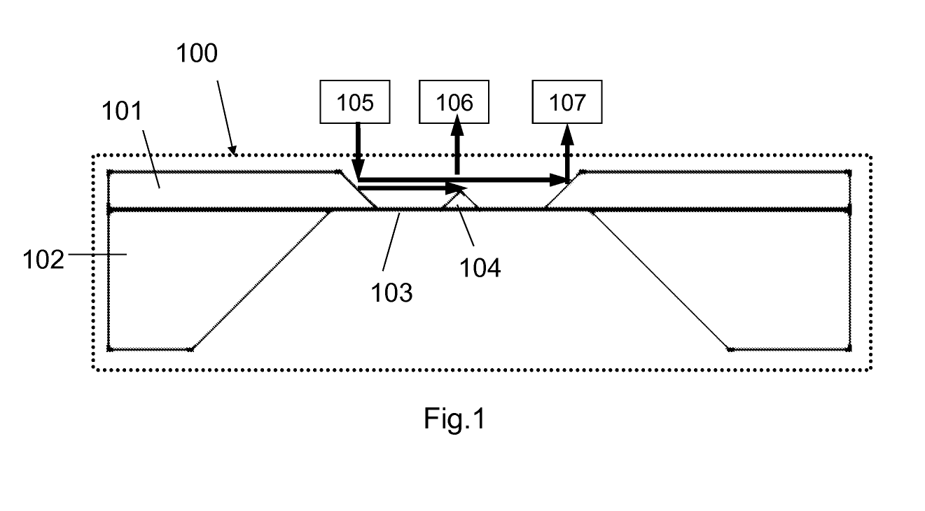

FIG. 1 shows an optical sensor according to one embodiment of the present invention. In this embodiment, the optical sensor comprises a vibration sensing device 100 including a first substrate 101 with an optical micro-reflection surface, a second substrate 102, a membrane 103, and an optical gate 104. Moreover, a light source 105, and a photo detector 106, 107 may be integrated with the vibration sensing device 100 to be as an optical sensing system, optical sensing module or optical sensing component. The membrane 103 is disposed between the first substrate 101 and the second substrate 102. The optical gate 104 is formed (disposed) on the membrane 103. In one embodiment, the optical gate 104 may be attached (pre-formed) or fixed on the membrane 103. The light source 105 is disposed above the first substrate 101. The light source 105 is capable of emitting visible and invisible light. The light source 105 is for example a laser, infrared light or a light emitting diode (LED).

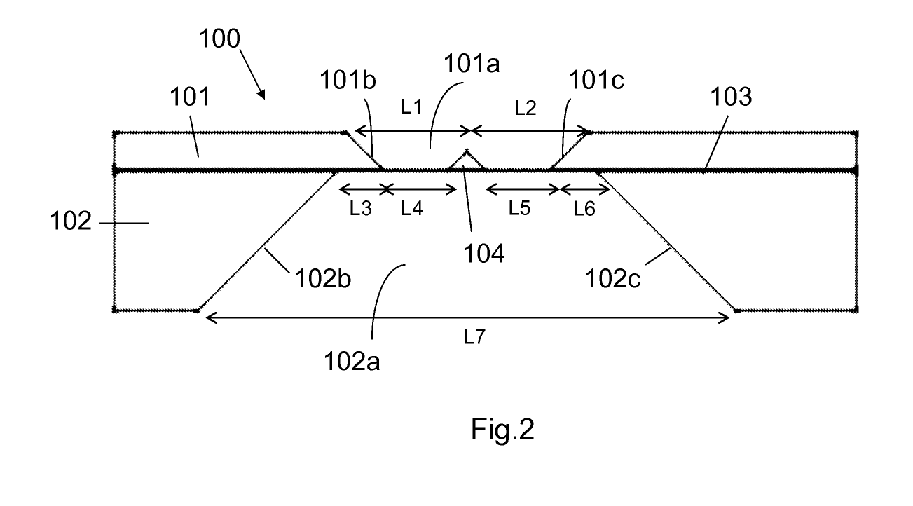

FIG. 2 shows a structure of the optical sensor of the FIG. 1. The first substrate 101 is used to be as an optical bench, and has a concave bench for facilitating the optical gate 104 to be disposed thereon, and optical micro-reflection surface having a specified angle (such as 45 degree angle). In one embodiment, the first substrate 101 has a first trench (concave structure) 101a in a specified depth beneath the top surface thereof. A first reflector is defined at a first end of the first trench 101a in the first substrate 101, and a second reflector is defined at a second end of the first trench 101a in the first substrate 101. The first end of the concave structure forms a first reflection surface, and the second end of the concave structure forms a second reflection surface. Based-on the concave structure, the optical gate 104 may be disposed on the bottom surface of the concave structure, within the first trench 101a. The first trench 101a has a first slant plane 101b and a second slant plane 101c. The optical gate 104 has a third slant plane and a fourth slant plane. Similarly, the second substrate 102 has a second trench 102a. The second trench 102a has a fifth slant plane 102b and a sixth slant plane 102c. In one embodiment, the optical bench (first substrate) 101 may include a micro-reflection surface (first slant plane) 101b having a 45 degree angle and a micro-reflection surface (second slant plane) 101c having a 45 degree angle, wherein the micro-reflection surface 101b is opposite to the micro-reflection surface 101c. The first trench 101a faces up, and the second trench 102a faces down.

For example, the light source 105 locates right above the first reflection surface 101b of the first substrate 101, and the photo detector 106, 107 are disposed right above the optical gate 104 and second reflection surface 101c of the first substrate 101, respectively. Therefore, the optical path of the light source 105 includes optical signal emitted by the light source 105 is reflected by the first reflection surface 101b of the first substrate 101 to enter into the optical gate 104, or reflected by the first reflection surface 101b of the first substrate 101 passing through the optical gate 104 to enter into the second reflection surface 101c of the first substrate 101.

The visible light or invisible light emitted by the light source 105 is propagating to the optical micro-reflector 101b of the first substrate 101 to reflect forward to the optical gate 104, followed by reflecting by the optical gate 104 or reflecting by the optical micro-reflector 101c of the first substrate 101 to be received by the photo detector 106 or the photo detector 107, respectively.

The third reflection surface (slant plane) of the optical gate 104 and the fourth reflection surface (slant plane) of the optical gate 104 are respectively located at opposite sides of the concave structure 101. Each of the third reflection surface and/or the fourth reflection surface has a 45 degree included angle as optical micro-reflection surface required for receiving by the photo detector 106.

Based-on the sensing of the vibration sensing device 100, function of vibration-detection can be achieved. The vibration sensing device 100 is used to be as a vibration-detection component with vibration sensing function for detecting sound waves, mechanical waves, seismic waves . . . and shock wave energy arisen by any other medium shocking. The vibration sensing device 100 integrates a light source 105, and a photo detector 106, 107 to be as an optical sensing system. Thus, the present invention uses an optical sensing system as vibration-detection system.

Disposed location, number, height and size of the optical gate 104 depend on requirements for practical applications (various signal waves, detected sources). Material and thickness of the first substrate 101, the second substrate 102 and the membrane 103 may be selected, based-on requirements for practical applications (various signal waves, detected sources). For example, material of the first substrate 101 and the second substrate 102 is silicon. Therefore, the first trench 101a and the second trench 102a may be formed by a standard semiconductor process (photolithography process, etching process). For example, the membrane 103 is a flexible thin film.

Moreover, dimension for L1˜L7, shown in FIG. 2, may be designed for practical applications (various signal waves, detected sources). L1: horizontal distance between top of the first slant plane 101b and top of the third slant plane L2: horizontal distance between top of the first slant plane 101c and top of the fourth slant plane L3: horizontal distance between top of the fifth slant plane 102b and bottom of the first slant plane 101b

L4: horizontal distance between bottom of the first slant plane 101b and bottom of the third slant plane

L5: horizontal distance between bottom of the fourth slant plane and bottom of the second slant plane 101c

L6: horizontal distance between bottom of the second slant plane 101c and top of the sixth slant plane 102c

L7: horizontal distance between bottom of the fifth slant plane 102b and bottom of the sixth slant plane 102c

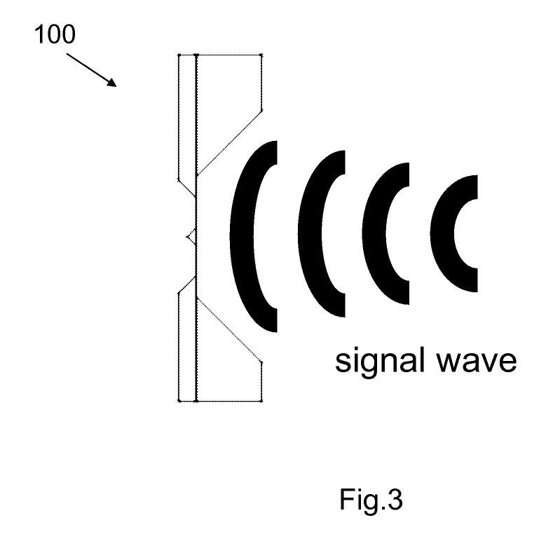

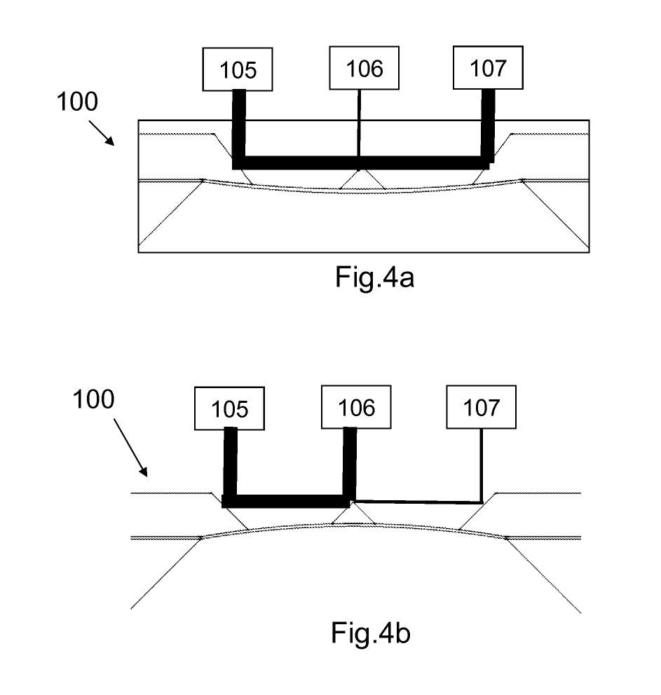

As signal wave reaches to the vibration sensing device 100, the membrane 103 and the optical gate 104 are vibrated by the signal wave, shown in FIG. 3. For example, vibration of the membrane 103 and the optical gate 104 will move up and down, and therefore light emitted by the light source 105 will be received by the photo detector 106 or the photo detector 107, shown in FIG. 4A and FIG. 4B. Thus, light intensity detected by the photo detector 106 and the photo detector 107 will be changed (increasingly) with the vibration of the optical gate 104. The intensity of light detected will be converted into electrical signal output. Accordingly, function of vibration-detection can be achieved.

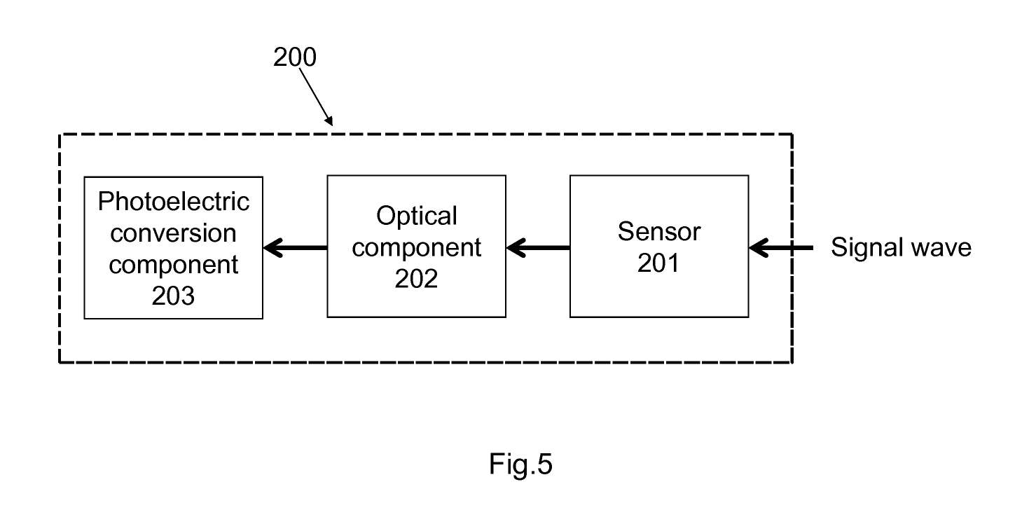

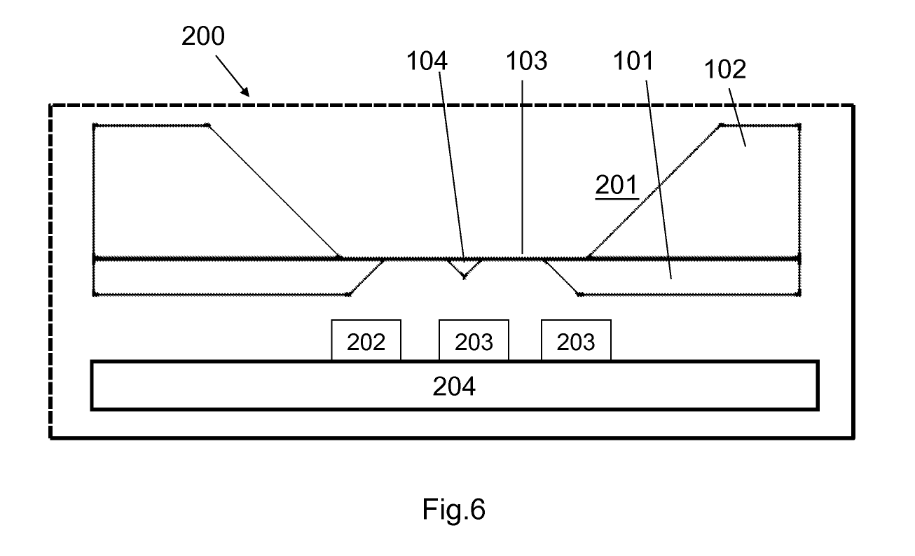

FIG. 5 shows an optical sensor system according to one embodiment of the present invention. In this embodiment, the optical sensor system 200 comprises an optical sensor 201, an optical component 202 and a photoelectric conversion component 203. The optical sensor 201 is for example the vibration sensing device 100 of FIG. 1. The optical component 202 may include a light source. The photoelectric conversion component 203 is for example photo detectors, used for converting optical signal to electrical signal. In this embodiment, the optical sensor 201, the optical component 202 and the photoelectric conversion component 203 may integrated on a substrate (printed circuit board) 204, shown in FIG. 6. The light source 202 and photo detectors 203 are mounted to the substrate 204. The optical sensor 201 is then mounted to the substrate 204. The light source 202 aligns substantially to the first reflection surface of the first substrate 101, and the photo detector 203 aligns substantially to second reflection surface of the first substrate 101 or the optical gate 104.

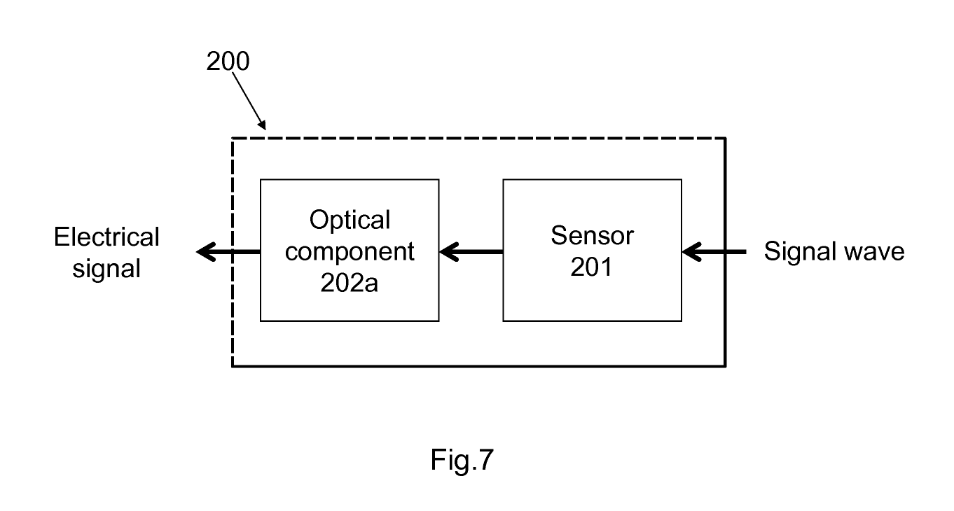

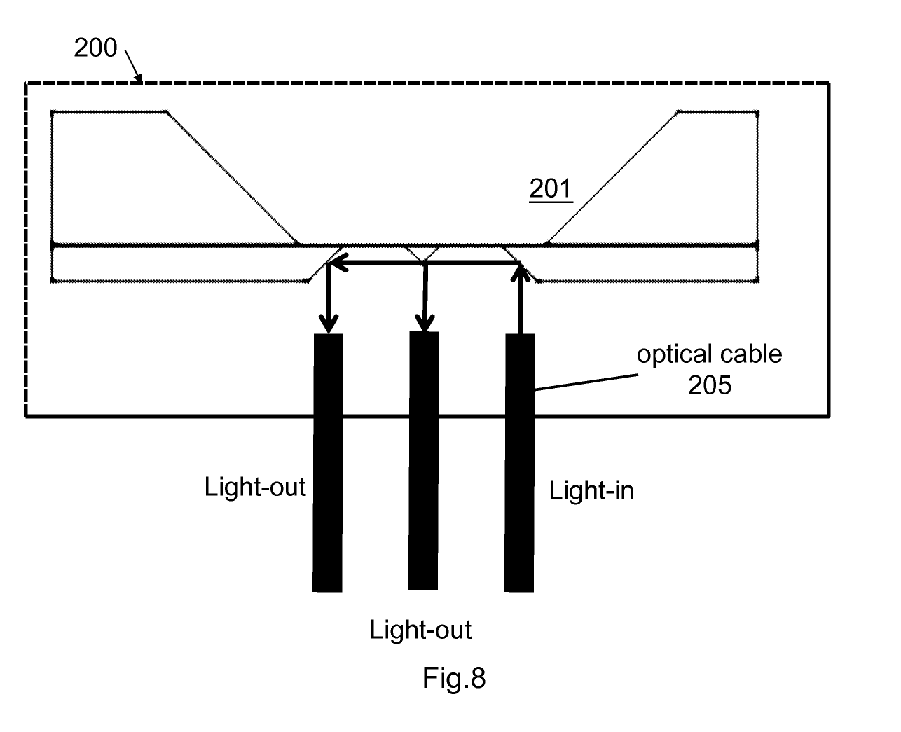

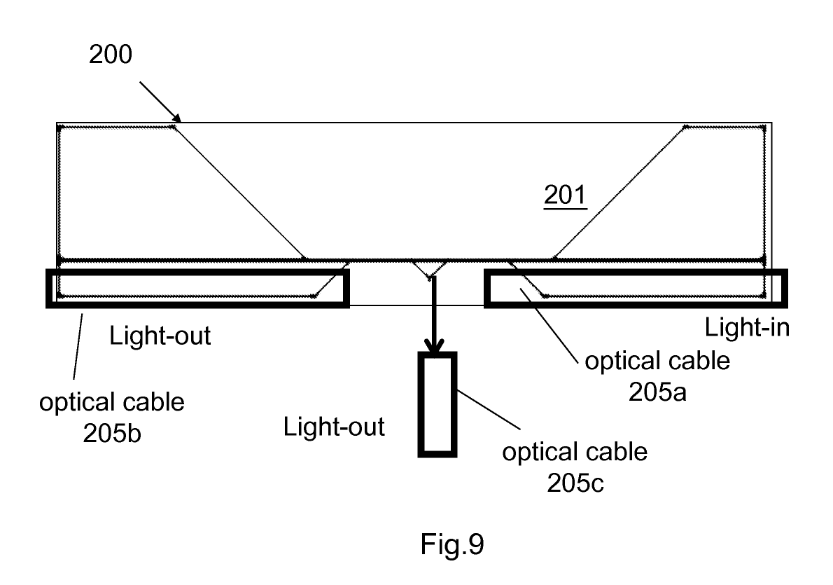

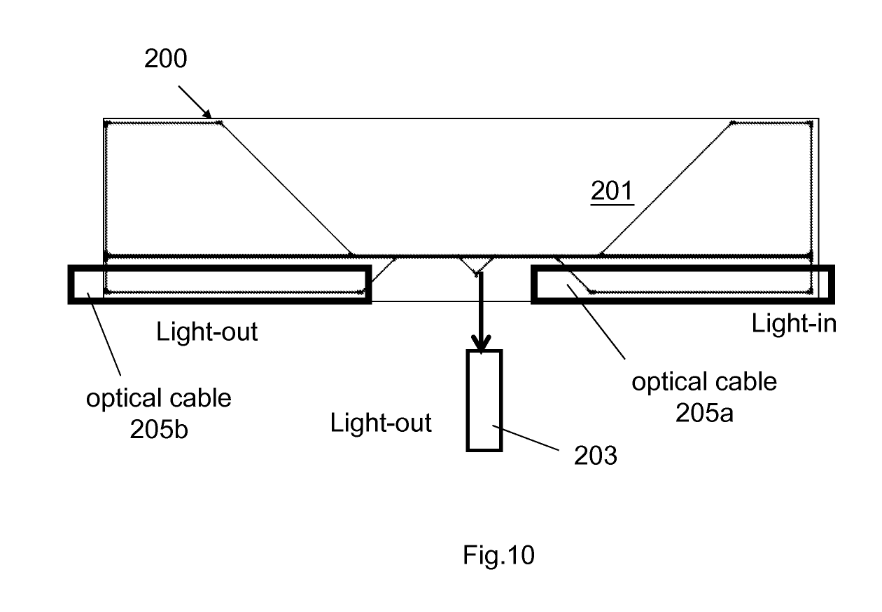

FIG. 7 shows an optical sensor system according to another embodiment of the present invention. In this embodiment, the optical sensor system 200 comprises an optical sensor 201, and an optical component 202a. The optical sensor 201 is for example the vibration sensing device 100 of FIG. 1. The optical component 202a may include an optical cable 205, shown in FIG. 8. In one embodiment, optical component 202a may include a fiber connector. The photoelectric conversion component is for example photo detectors, used for converting optical signal to electrical signal. In this embodiment, the optical sensor 201 and the optical component 202a may integrated on a substrate (printed circuit board). In one embodiment, a fiber may be disposed into the optical cable 205 for coupling to light source and photo detector for light-in and light-out, respectively. In another embodiment, at least one groove (not shown) is formed on the concave structure of the first substrate. Based-on the at least one groove of the concave structure, the optical cable 205a and 205b may be passively aligned to the at least one groove, shown in FIG. 9. Thus, light emitted by the light source may be light-in via the optical cable 205a, and light-out via optical cable 205b and 205c, respectively. In another example, light reflected by the optical gate may be light-out to photo detector 203, shown in FIG. 10.

According to FIGS. 8-10, the optical cable aligns substantially to the first optical micro-reflection surface of the first substrate, the second optical micro-reflection surface of the first substrate or the optical gate. The optical cable may be integrated into the first substrate. A photoelectric conversion component may be disposed under the optical gate, and aligns substantially to the optical gate.

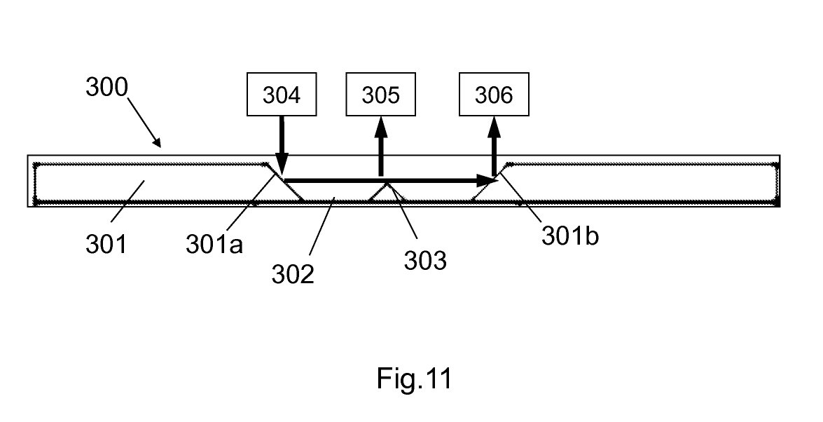

FIG. 11 shows an optical sensor according to another embodiment of the present invention. In this embodiment, the optical sensor 300 comprises a substrate 301 with an optical micro-reflection surface 301a, 301b, a membrane 302, and an optical gate 303. Moreover, a light source 304, and a photo detector 305, 306 may be integrated with the optical sensor 300 to be as an optical sensing system, optical sensing module or optical sensing component. The substrate 301, the membrane 302, and the optical gate 303 is similar to the first substrate 101, the membrane 103, and the optical gate 104 of FIG. 1, respectively. Therefore, the detailed description is omitted.

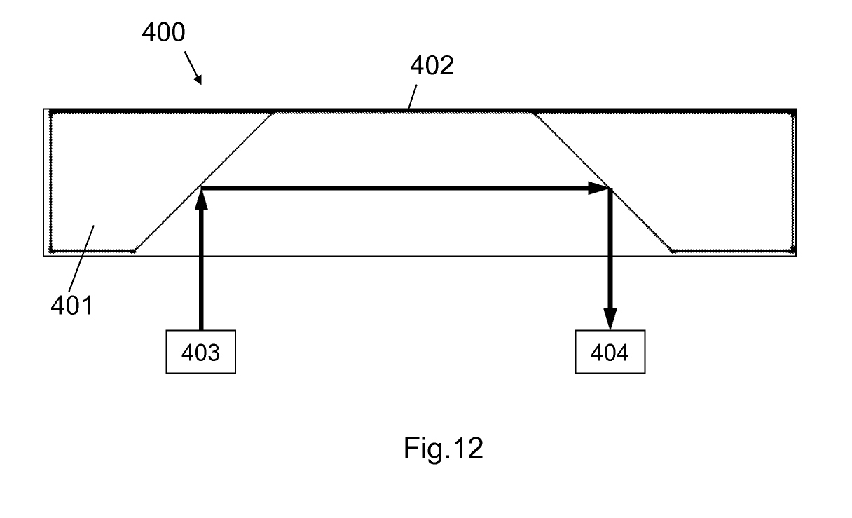

FIG. 12 shows an optical sensor according to yet another embodiment of the present invention. In this embodiment, the optical sensor 400 comprises a substrate 401 with optical micro-reflection surface, and a membrane 402. In this example, an optical gate is not included. Moreover, a light source 403, and a photo detector 404 may be integrated with the optical sensor 400 to be as an optical sensing system, optical sensing module or optical sensing component. The substrate 401 and the membrane 402 are similar to the first substrate 101, the membrane 103 of FIG. 1, respectively. Therefore, the detailed description is omitted.

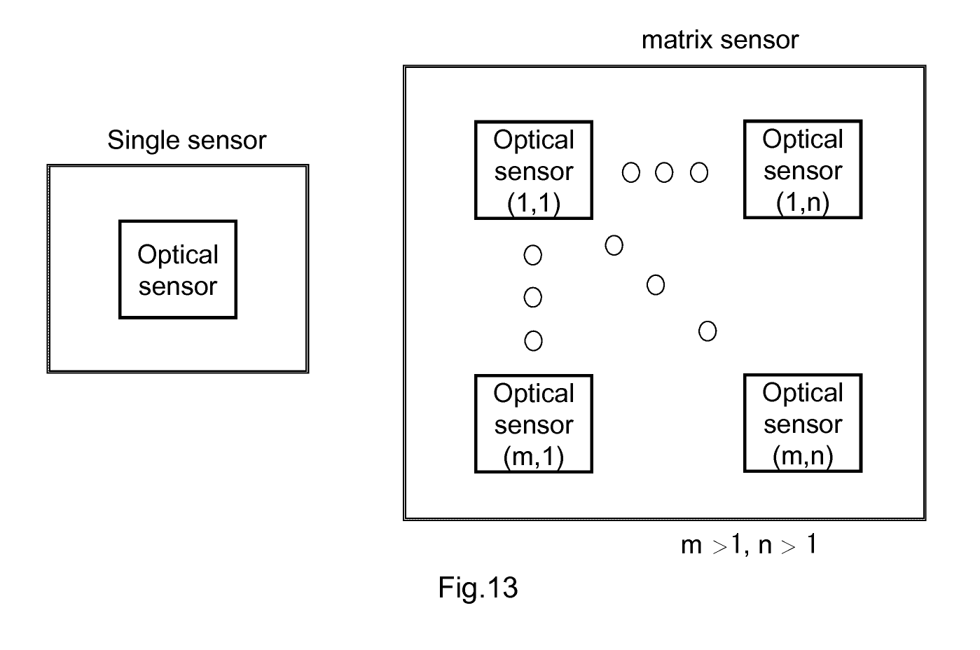

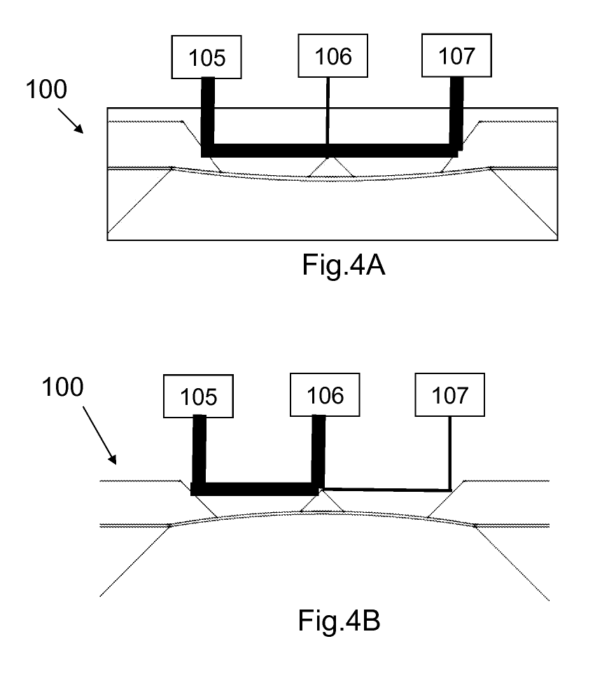

In another embodiment, the optical sensor may be a single optical sensor or an optical sensor array (matrix sensor), shown in FIG. 13. The matrix sensor is constructed by m×n matrix optical sensors, wherein number of m and n are integer larger than one.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. An optical sensor, comprising:
a substrate with a concave structure having a first optical micro-reflection surface and a second optical micro-reflection surface formed thereon; and
a membrane configured on said substrate.

2. The optical sensor of claim 1, wherein a material of said substrate is silicon.

3. The optical sensor of claim 1, wherein said membrane is a flexible thin film.

4. The optical sensor of claim 1, further comprising an optical gate disposed on said membrane within said concave structure.

5. The optical sensor of claim 4, further comprising a second substrate, wherein said membrane is disposed between said substrate and said second substrate.

6. The optical sensor of claim 5, wherein said second substrate has a second concave structure having a third optical micro-reflection surface and a fourth optical micro-reflection surface formed thereon.

7. An optical sensor system, comprising:
an optical sensor having a first substrate with a first concave structure having a first optical micro-reflection surface and a second optical micro-reflection surface formed thereon, a second substrate with a second concave structure having a third optical micro-reflection surface and a fourth optical micro-reflection surface formed thereon, a membrane configured between said first and said second substrate, and an optical gate disposed on said membrane within said first concave structure; and
a third substrate, wherein an optical component and a photoelectric conversion component are integrated on said third substrate;
wherein said optical component aligns substantially to said first optical micro-reflection surface of said first substrate, and said photoelectric conversion component aligns substantially to said second optical micro-reflection surface of said first substrate or said optical gate.

8. The optical sensor system of claim 7, wherein a material of said first substrate is silicon.

9. The optical sensor system of claim 7, wherein a material of said second substrate is silicon.

10. The optical sensor system of claim 7, wherein said third substrate is a printed circuit board.

11. The optical sensor system of claim 7, wherein said membrane is a flexible thin film.

12. The optical sensor system of claim 7, wherein said optical component is a light source.

13. The optical sensor system of claim 7, wherein said photoelectric conversion component is a photo detector.

14. An optical sensor system, comprising:
an optical sensor having a first substrate with a first concave structure having a first optical micro-reflection surface and a second optical micro-reflection surface formed thereon, a second substrate with a second concave structure having a third optical micro-reflection surface and a fourth optical micro-reflection surface formed thereon, a membrane configured between said first and said second substrate, and an optical gate disposed on said membrane within said first concave structure; and
at least one optical cable aligning substantially to said first optical micro-reflection surface of said first substrate, said second optical micro-reflection surface of said first substrate or said optical gate.

15. The optical sensor system of claim 14, wherein a material of said first substrate is silicon.

16. The optical sensor system of claim 14, wherein a material of said second substrate is silicon.

17. The optical sensor system of claim 14, wherein said at least one optical cable is integrated into said first substrate.

18. The optical sensor system of claim 14, wherein said membrane is a flexible thin film.

19. The optical sensor system of claim 14, further comprising a photoelectric conversion component disposed under said optical gate.

20. The optical sensor system of claim 19, wherein said photoelectric conversion component is a photo detector.
